(19) United States
(12) Patent Application Publication
(10) Pub. No.: US 2003/0106434 A1
(43) Pub. Date: Jun. 12, 2003

(54) Coffee maker with improved screen mounting

(76) Inventor: Helmut Kaiser, Wolfratshausen (DE)

Correspondence Address: LERNER AND GREENBERG, P.A., Post Office Box 2480, Hollywood, FL, 33022-2480, US

(21) Appl. No.: 10/337,529

(22) Filed: Jan. 7, 2003

Related U.S. Application Data
(63) Continuation of application No. PCT/EP01/07567, filed on Jul. 2, 2001.

(30) Foreign Application Priority Data
Jul. 7, 2000 (DE) 100 33 090.8

(51) Int. Cl. A47J 31/00; A23F 3/00

(52) U.S. Cl. 99/279

(57) ABSTRACT

A coffee maker includes a housing body having a base and a filter region disposed above the base, an accommodating space for a coffee pot formed between the base and the filter region, and a screen fastened in a releasable manner on the housing body, in the filter region, through at least one retainer, the screen being disposed on the front side of the coffee maker. The base has a recess, the screen has at least one side surface guided laterally along the accommodating space, and the side surface is connected in a releasable manner to the housing body, in the region of the accommodating space, by in each case the at least one retainer.

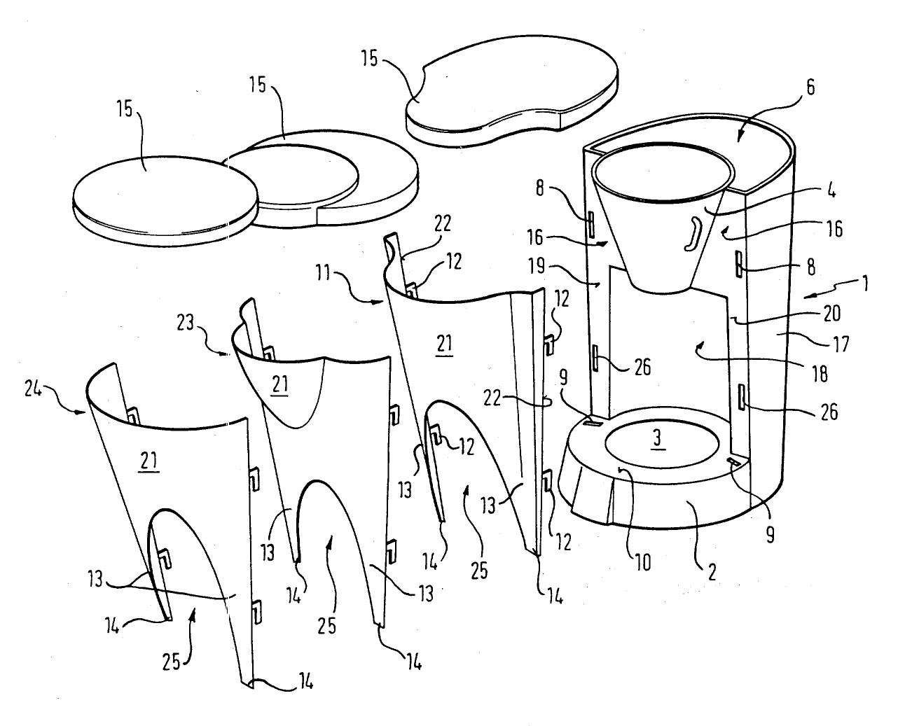

### CROSS-REFERENCE TO RELATED APPLICATION:

This application is a continuation of copending International Application No. PCT/EP01/07567, filed Jul. 2, 2001, which designated the United States and was not published in English.

### BACKGROUND OF THE INVENTION

### Field of the Invention

The invention relates to a coffee maker with a housing body having a base and a filter region disposed above the base, an accommodating space for a coffee pot being formed between the base and the filter region, a screen releasably fastened on the housing body, in the filter region, with a retainer, the screen being disposed on the front side of the coffee maker.

A generic coffee maker is represented by the Philips Cucina 7502 coffee maker, in which a screen is hooked into recesses of a pivotable filter holder through snap-in hooks.

### SUMMARY OF THE INVENTION

It is accordingly an object of the invention to provide a coffee maker that overcomes the hereinafore-mentioned disadvantages of the heretofore-known devices of this general type and that improves mounting of the screen on the coffee maker.

With the foregoing and other objects in view, there is provided, in accordance with the invention, a coffee maker, including a housing body having a base with a recess, a filter region disposed above the base, and a front side, the housing body defining an accommodating space for a coffee pot between the base and the filter region, and a screen having at least one retaining device releasably fastening the screen to the housing body at the filter region, the screen being disposed at the front side when fastened to the housing body, and at least one side surface releasably connected to the housing body in a region of the accommodating space by the at least one retaining device, the at least one side surface being laterally guided along the accommodating space when the screen is fastened to the housing body.

In accordance with another feature of the invention, the screen, preferably, has at least one side surface, which is guided laterally, at least in part, along an accommodating space for a coffee pot, and the side surface is connected to the housing body, in the region of the accommodating space, by a releasable retainer or retaining means. Such an embodiment provides the significant advantage that the configuration of the side surface creates the look of a relatively large front region of the coffee maker. In addition, the fastening of the side surface on the housing body provides, overall, improved fastening of the screen on the coffee maker.

In accordance with a further feature of the invention, the screen has an endpiece, extends as far as the base, and engages in the recess by the endpiece.

In accordance with an added feature of the invention, the screen has at least one endpiece and extends to the base and the at least one endpiece engages in the recess.

In accordance with an additional feature of the invention, the retainer is in the form of a hook on the screen and of a recess in the housing of the coffee machine. This makes it possible for the screen to be fitted simply by the hook being hooked into the recess of the housing, and to be removed again just as straightforwardly.

In accordance with yet another feature of the invention, in each case two retainers are disposed at the same height in the filter region, to the sides of a filter holder, and in each case two retainers are disposed at the same height, in the region of the accommodating space, on two housing-body front sides that bound the accommodating space. Such an advantageous configuration of the retainer allows the screen to be fastened securely on the housing body, the screen butting uniformly against the housing body over its outer edge.

In accordance with yet a further feature of the invention, the hook is two hooks respectively engaging one of the two recesses.

In accordance with yet an added feature of the invention, the base of the coffee machine has a recess in which the side surface engages. Using the recess in the base allows further fixing of the side surface, with the result that the fastening of the screen is additionally stabilized. The recess also makes it possible to fasten side surfaces of different lengths on a coffee maker, the side-surface ends of different lengths disappearing from view in the recess. Using the recess in the base additionally makes it possible for coffee makers of different types to be provided with one and the same screen, the different height positions of the screens being compensated for by pushing the endpiece of the side surface into the recess of the base. It is, thus, sufficient to provide one type of screen for coffee makers of different heights. Such a configuration allows the coffee maker to be produced in a particularly cost-effective manner.

In accordance with yet an additional feature of the invention, the hook is four hooks respectively engaging one of the two recesses and the two further recesses.

In accordance with again another feature of the invention, the housing body has a filter holder and two front sub-surfaces bounding the accommodating space and the recess is two recesses disposed at approximately a same level on the housing body in a region of the filter holder.

In accordance with again a further feature of the invention, the screen has two lateral surfaces that are each guided laterally along the accommodating space and engage in a recess of the base by way of an endpiece in each case. The front side of the coffee machine can be largely created by the use of a screen with two side surfaces. In addition, precise fixing of the side surfaces on the housing body is possible as a result of the endpieces of the side surfaces engaging in the recesses of the base.

In accordance with again an added feature of the invention, the base has a top side associated with the accommodating space and the recess is formed on the top side. Preferably, the top side defines a portion of the accommodating space.

In accordance with again an additional feature of the invention, the screen has at least one endpiece and extends to the base, the at least one endpiece engages in the recess, the base has a top side defining a portion of the accommodating space, the housing body has two front sub-surfaces bounding the accommodating space, the recess is formed on the top side adjacent the first and second front sub-surfaces and the screen is retained flush against the housing body on the first and second front sub-surfaces when the at least one endpiece engages in the recess.

In accordance with still another feature of the invention, the screen is releasably fastened on the housing body in the filter region and the screen is disposed on the front side.

With the objects of the invention in view, there is also provided a coffee maker, including a housing body having a filter region, a wall defining at least one first recess at the filter region, a base with at least one second recess, the base disposed below the filter region, and a front side, the housing body defining an accommodating space for a coffee pot between the base and the filter region, and a screen having at least one endpiece engaging in the at least one second recess when the screen is fastened to the housing body, at least one hook releasably fastening the screen to the housing body at the at least one first recess, the screen being disposed at the front side when fastened to the housing body, and at least one side surface releasably connected to the housing body in a region of the accommodating space by the at least one hook, the at least one side surface being laterally guided along the accommodating space when the screen is fastened to the housing body.

In accordance with still a further feature of the invention, the at least one side surface is two side surfaces each guided laterally along the accommodating space, the at least one second recess is two second recesses, and the at least one endpiece is two endpieces each disposed at a respective one of the two side surfaces and each engaging in a respective one of the second recesses.

In accordance with still an added feature of the invention, the base has a top side, and the two second recess are formed on the top side.

In accordance with still an additional feature of the invention, the screen is retained entirely flush against the housing body when the screen is fastened to the housing body.

With the objects of the invention in view, there is also provided a coffee maker, including a housing body having a base with a recess, a filter region disposed above the base, and a front side, the housing body defining an accommodating space for a coffee pot between the base and the filter region, and a screen having retaining means releasably fastening the screen to the housing body at the filter region, the screen being disposed at the front side when fastened to the housing body, and at least one side surface releasably connected to the housing body in a region of the accommodating space by the retaining means, the at least one side surface being laterally guided along the accommodating space when the screen is fastened to the housing body.

Other features that are considered as characteristic for the invention are set forth in the appended claims.

Although the invention is illustrated and described herein as embodied in a coffee maker with improved screen mounting, it is, nevertheless, not intended to be limited to the details shown because various modifications and structural changes may be made therein without departing from the spirit of the invention and within the scope and range of equivalents of the claims.

The construction and method of operation of the invention, however, together with additional objects and advantages thereof, will be best understood from the following description of specific embodiments when read in connection with the accompanying drawings.

### BRIEF DESCRIPTION OF THE DRAWING

The figure is an exploded perspective view of a housing body of a coffee maker with three different embodiments of a screen according to the invention and three different embodiments of a cover according to the invention.

### DESCRIPTION OF THE PREFERRED EMBODIMENTS

Referring now to the single figure of the drawing, it is seen that a coffee-maker housing body 1 has a base 2, a body 17, and a non-pivotable filter holder 4. The base 2 has a hot plate 3 or, if the intention is to realize a thermal-carafe coffee maker, an appropriate base plate. A body 17 extends upwards from the base 2 and has the filter holder 4 in the top region. A water tank 6 is integrated in the body 17. The body 17, beneath the filter holder 4, has a part-cylindrical recess 18, which constitutes an accommodating space for setting down a glass coffee pot or thermal carafe. The body 17 has a semi-oval base surface resting on a part-annular outer edge region of a top side 10 of the base 2. A hot plate 3 is disposed in the center of the top side 10. The body 17 has a front surface or side 16 that is disposed virtually perpendicularly to the top side 10 and is formed above the base 2. The front surface 16 is subdivided into a first front sub-surface 19 and a second front sub-surface 20, which extend, on opposite sides, from the top side 10 of the base 2 and are guided laterally past the accommodating space, in the upward direction, as far as the top edge of the filter holder 4. A first recess 8 in the form of a vertical longitudinal slot is made at the same level in each case in the first and the second front sub-surfaces 19, 20, in the region of the filter holder 4. In addition, in the region of the recess 18, two further recesses 26 in the form of vertical longitudinal slots are made at the same level in the first and second front sub-surfaces 19, 20.

The top side 10 of the base 2 has two second recesses 9 in the form of slots in the vicinity of the first and the second front sub-surfaces 19, 20. The shape of the second recess 9 is adapted to the cross section of the endpieces 14 of side surfaces 13. As a result, the end pieces 14 can be pushed, preferably, in a precisely fitting manner into the second recesses 9. The second recesses 9 are disposed on the top side 10 such that a screen 11, 23, 24, in the fitted state, butts in a form-fitting manner against the front side 16 by way of the side edge 22 in the region of the top side 10.

The figure illustrates a first screen 11 in front of the housing body 1. The first screen 11 has a main surface 21 from which two separate side surfaces 13 extend downward. The side surfaces 13 constitute an extension of the main surface in the downward direction. The two side surfaces 13 bound a semi-oval part-opening 25 by way of the main surface 21. The part-opening 25, in the fitted state of the first screen 11, is disposed in front of the recess 18 and defines the size of the opening of the accommodating space. The screen 11 is configured, in cross-section, as a curved plate, on the side edges 22 of which in each case two hooks 12 are formed. The hooks 12 of a side edge 22 are spaced apart from one another by a distance that corresponds to the distance between the recesses 8 of a front sub-surface 19, 20.

The figure shows a second screen 23 and a third screen 24, which differ from the first screen 11 substantially in the region of the main surface 21, although the second and third screens 23, 24 also have hooks 12 on their respective side edges. In addition, the second and third screens 23, 24, likewise, have a main surface 21 that merges into the two side surfaces 13 bounding the part-opening 25. The main surface 21 and/or the sub-surfaces 13 are defined differently for the screens 11, 23, 24 in order to make it possible for the coffee maker, while having the same basic body, to have a different appearance. The two hooks 12 of a side edge 22 of the second and third screens 23, 24 are spaced apart from one another by a distance that corresponds to the distance between the two recesses 8 of a front sub-surface 19, 20. Depending on the screen selected, the resulting coffee maker, while having the same basic body, has a different appearance.

The first, second, and third screens 11, 23, 24 are configured such that, in the case of a screen being fitted into the recesses 8, 26, a bottom endpiece 14 of the side surfaces 13 engages in the correspondingly shaped second recesses 9. As such, the screen is fixed and retained through the second recess 9 in addition to the four hooks. Such fastening allows precise abutment against the front surface 16 in the edge region of the screens 11, 23, 24.

Using the second recess 9 also makes it possible for housing bodies 1 of different heights to be provided with a screen 11, 23, 24 of fixed height, in which case, depending on the height of the housing body 1, the screen 11, 23, 24 is pushed to different extents into the second recess 9 by way of the endpieces 14. Such a configuration allows cost-effective production of different coffee makers with a screen of standard height. For example, coffee makers differ in height if the same type of coffee maker is provided not with a glass pot, but with a thermal carafe of considerably greater height. The hooks 12 and the associated recess 8 constitute a releasable retainer by which the screens 11, 23, 24 are fastened on the housing body 1. Using the four recesses 8, 26 and the four hooks 12 makes it possible for the screens 11, 23, 24 to be fastened securely on the housing body 1, the shape of the screens 11, 23, 24 resulting in not just the filter holder 4 but also the accommodating space being bounded laterally by at least one side surface 13 and being partially covered. It is, thus, possible for the look of the coffee maker to be largely created by the screens 11, 23, 24. The further recesses 26 and the correspondingly associated hooks 12 make it possible for the screen to butt in a form-fitting manner against the front sub-surface 19, 20 over the entire side edge of the screen 11, 23, 24. The recesses 8, here, are disposed outside the water tank to avoid sealing problems. In addition, or as an alternative, to the hooks 12 illustrated, it is also possible for the screens 11, 23, 24 to have hooks that are not illustrated but are disposed on the top edge of the screen. These hooks, then, would engage in the top edge section of the housing body 1.

The figure gives a perspective illustration of three variants of covers 15 that, in accordance with the different shapes of the screens 11, 23, 24, also differ in shape, and are used for positioning on the housing body 1 and the screens 11, 23, 24.

In a further non-illustrated embodiment, the housing body 1 only has the first recesses 8 to the sides of the filter holder 4 and the second recesses 9. Correspondingly, the screen 11, 23, 24 fitted on the housing body 1 only has top hooks 12, which are hooked into the first recesses 8. The endpieces 14 of the screen 11, 23, 24, in the fitted state of the screens 11, 23, 24, are inserted into the second recesses 9.

A further non-illustrated embodiment of the invention lies in the screen only having one side surface 13 and in just this one side surface 13, in the fitted state on the housing body 1, being pushed into a corresponding second recess 9 by way of an endpiece.

A further particularly straightforward non-illustrated embodiment dispenses with the second recesses 9, one side surface 13 or the two side surfaces 13 of the screen 11, 23, 24, depending on the embodiment, being hooked into the first and the further recesses 8, 26 through hooks 12.

I claim:

1. A coffee maker, comprising:
a housing body having:
a base with a recess;
a filter region disposed above said base; and
a front side;
said housing body defining an accommodating space for a coffee pot between said base and said filter region; and
a screen having:
at least one retaining device releasably fastening said screen to said housing body at said filter region, said screen being disposed at said front side when fastened to said housing body; and
at least one side surface releasably connected to said housing body in a region of said accommodating space by said at least one retaining device, said at least one side surface being laterally guided along said accommodating space when said screen is fastened to said housing body.

2. The coffee maker according to claim 1, wherein said screen has an endpiece, extends as far as said base, and engages in said recess by said endpiece.

3. The coffee maker according to claim 1, wherein:
said screen has at least one endpiece and extends to said base; and
said at least one endpiece engages in said recess.

4. The coffee maker according to claim 3, wherein:
said housing body has a wall; and
said at least one retaining device is:
a recess defined by said wall; and
a hook formed on said screen.

5. The coffee maker according to claim 1, wherein:
said housing body has a wall; and
said at least one retaining device is:
a recess defined by said wall; and
a hook formed on said screen.

6. The coffee maker according to claim 5, wherein:
said housing body has a filter holder and two front sub-surfaces bounding said accommodating space; and
said recess is:
two recesses disposed at approximately a same level on said housing body in a region of said filter holder; and
two further recesses disposed at approximately a same level in a region of said accommodating space on a respective one of said two front sub-surfaces.

7. The coffee maker according to claim 6, wherein said hook is two hooks respectively engaging one of said two recesses.

8. The coffee maker according to claim 6, wherein said hook is four hooks respectively engaging one of said two recesses and said two further recesses.

9. The coffee maker according to claim 5, wherein:
said housing body has a filter holder and two front sub-surfaces bounding said accommodating space; and
said recess is two recesses disposed at approximately a same level on said housing body in a region of said filter holder.

10. The coffee maker according to claim 9, wherein said hook is two hooks respectively engaging one of said two recesses.

11. The coffee maker according to claim 3, wherein:
said screen has two side surfaces;
said at least one endpiece is two endpieces each disposed at one of said two side surfaces;
said base defines two second recesses; and
said two side surfaces are each guided laterally along said accommodating space, each of said endpieces engaging in a respective one of said second recesses.

12. The coffee maker according to claim 1, wherein:
said base has a top side associated with said accommodating space; and
said recess is formed on said top side.

13. The coffee maker according to claim 1, wherein:
said base has a top side defining a portion of said accommodating space; and
said recess is formed on said top side.

14. The coffee maker according to claim 1, wherein:
said screen has at least one endpiece and extends to said base;
said at least one endpiece engages in said recess;
said base has a top side defining a portion of said accommodating space;
said housing body has two front sub-surfaces bounding said accommodating space;
said recess is formed on said top side adjacent said first and second front sub-surfaces; and
said screen is retained flush against said housing body on said first and second front sub-surfaces when said at least one endpiece engages in said recess.

15. The coffee maker according to claim 1, wherein said screen is releasably fastened on said housing body in said filter region.

16. The coffee maker according to claim 15, wherein said screen is disposed on said front side.

17. A coffee maker, comprising:
a housing body having:
a filter region;
a wall defining at least one first recess at said filter region;
a base with at least one second recess, said base disposed below said filter region; and
a front side;
said housing body defining an accommodating space for a coffee pot between said base and said filter region; and
a screen having:
at least one endpiece engaging in said at least one second recess when said screen is fastened to said housing body;
at least one hook releasably fastening said screen to said housing body at said at least one first recess, said screen being disposed at said front side when fastened to said housing body; and
at least one side surface releasably connected to said housing body in a region of said accommodating space by said at least one hook, said at least one side surface being laterally guided along said accommodating space when said screen is fastened to said housing body.

18. The coffee maker according to claim 17, wherein:
said at least one side surface is two side surfaces each guided laterally along said accommodating space;
said at least one second recess is two second recesses; and
said at least one endpiece is two endpieces each disposed at a respective one of said two side surfaces and each engaging in a respective one of said second recesses.

19. The coffee maker according to claim 18, wherein:
said base has a top side; and
said two second recess are formed on said top side.

20. The coffee maker according to claim 17, wherein said screen is retained entirely flush against said housing body when said screen is fastened to said housing body.

21. A coffee maker, comprising:
a housing body having:
a base with a recess;
a filter region disposed above said base; and
a front side;
said housing body defining an accommodating space for a coffee pot between said base and said filter region; and
a screen having:
retaining means releasably fastening said screen to said housing body at said filter region, said screen being disposed at said front side when fastened to said housing body; and
at least one side surface releasably connected to said housing body in a region of said accommodating space by said retaining means, said at least one side surface being laterally guided along said accommodating space when said screen is fastened to said housing body.
